(19) United States
(12) Patent Application Publication
(10) Pub. No.: US 2026/0249226 A1
(43) Pub. Date: Aug. 27, 2026

(54) COMMUNICATING FILTER PLANTS

(71) Applicant: KAPPA FILTER SYSTEMS GMBH, Steyr-Gleink (AT)

(72) Inventors: Klaus KRÜGER, Steyr/St. Ulrich (AT); Urs HUNZIKER, Meilen (CH)

(73) Assignee: KAPPA FILTER SYSTEMS GMBH, Steyr-Gleink (AT)

(21) Appl. No.: 18/877,411

(22) PCT Filed: Jun. 28, 2023
(86) PCT No.: PCT/EP2023/067721

§ 371 Date: Dec. 20, 2024

(30) Foreign Application Priority Data
Jul. 1, 2022 (DE) 10 2022 116 521.3

(51) Int. Cl. B01D 46/46; B01D 39/16; B01D 46/00; B01D 46/42; B01D 46/44; B01D 46/54; F24F 8/108; F24F 11/74; F24F 110/10; F24F 110/20; F24F 110/30; F24F 110/40; F24F 110/64; F24F 110/70; F24F 110/72; F24F 110/76; F24F 120/12; F24F 130/40; F24F 140/60

(52) U.S. Cl. CPC B01D 46/46; B01D 39/1615; B01D 39/1623; B01D 46/0045; B01D 46/0086; B01D 46/4245; B01D 46/429; B01D 46/442; B01D 46/444; B01D 46/446; B01D 46/448; B01D 46/543; F24F 8/108; F24F 11/74; B01D 2239/0428; B01D 2273/30; B01D 2279/50; F24F 2110/10; F24F 2110/20; F24F 2110/30; F24F 2110/40; F24F 2110/64; F24F 2110/70; F24F 2110/72; F24F 2110/76; F24F 2120/12; F24F 2130/40; F24F 2140/60

(57) ABSTRACT

The present disclosure relates to a filter system for filtering air in rooms of a building. In one example, the filter system comprises a filter device comprising a fan unit and a filter element. The filter device comprises a sensor element for determining at least one filter device parameter comprising at least one air parameter or an operating parameter of the filter device. Furthermore, the filter system comprises a further sensor element configured for determining at least one further air parameter of the air at the further sensor element. The filter device further comprises a control unit configured to determine at least one room state or a filter state based on the filter device parameter and the further air parameter.

### TECHNICAL FIELD

The present invention relates to a filter system for filtering air in rooms of a building. Furthermore, the present invention relates to a method for filtering air in rooms of a building.

### BACKGROUND OF THE INVENTION

Filter systems in room air systems ensure the ventilation and venting of rooms in buildings and filter pollutants from the air. Primary filter plants are used in buildings which encompass, for example, central ventilation systems in a building and controlled ventilation of apartments. The primary filter plants can have a connection to the outside air. In addition, secondary filter plants are often used as a supplement to the primary filter plants. A secondary filter plant encompasses, for example, an air circulation system with filtering and is provided for installation in a room (for example room air cleaner).

The secondary filter plants are often operated independently of the primary filter plant in a building, so that the overall filter performance often does not meet the requirements or, on the other hand, is set too high for the actual requirement, so that energy is wasted unnecessarily.

### SUMMARY OF THE INVENTION

It is an object of the present invention to optimally adjust the filter performance in a building.

This object is solved with a filter system for filtering air in rooms of a building as well as a method for filtering air in rooms of a building according to the subject matter of the independent patent claims.

According to a first aspect, a filter system for filtering air in rooms of a building is described. The filter system comprises a filter device comprising a fan unit and a filter element which is placeable in a room. Air to be filtered is flowable by means of the fan unit through the filter element for filtering, wherein the filter device comprises a sensor element for determining at least one filter device parameter consisting of at least one air parameter (e.g. CO content, CO₂ content, rel. humidity, air pressure, O₂ content, foreign matter content) of the air to be filtered at the filter device and/or an operating parameter of the filter device (e.g. power consumption, air throughput, volume etc.).

Furthermore, the filter device comprises a further sensor element which is placeable spaced apart from the filter device (in the same room or in another room of the building) and is configured for determining at least one further air parameter (e.g. CO content, CO₂ content, rel. humidity, air pressure, O₂ content, foreign matter content) of the air at the further sensor element.

Furthermore, the filter device comprises a control unit which is coupled to the filter device and to the further sensor element and is configured to determine at least one room state (e.g. CO₂ room distribution, location-dependent foreign matter load, occupancy by persons (persons present/no persons present, distribution of the persons in the room, noise levels in the room etc.)

or a filter state (e.g. filter occupancy state, information regarding the necessity of a filter exchange, information regarding the necessity of a ventilation expectation necessary) based on the filter device parameter and the further air parameter.

According to a further aspect, a method for filtering air in rooms of a building with a filter system described above is described.

A filter system according to the invention is typically used in buildings for filtering and cleaning air or also for cleaning air in production processes of factories.

The filter device comprises, for example, a housing in which a filter element is arranged or a plurality of filter elements are arranged in series along the flow direction of the air through the filter device or parallel to the flow direction. The filter element can be exchangeably provided.

The filter element of the filter device comprises, for example, a flat filter material which is fixed in a circumferential support frame. The filter element can be configured as a pocket filter, wherein a plurality of pockets of filter material are fastened in the support frame and the air flow is introduced into the pockets in order to filter the inflowing air. Furthermore, the filter module can likewise be configured as a cartridge filter, hose filter, candle filter, compact filter and HEPA filter.

The fan unit of the filter device in particular sucks air to be filtered into the filter device so that the air flows through the filter element. The fan unit can comprise, for example, an axial compressor or a radial compressor and accordingly the air can flow in a straight line or at right angles along a translational flow. The fan unit can in particular be controlled by the control unit so that the air throughput through the filter device can be set.

The sensor element of the filter device is configured to determine at least one filter device parameter consisting of at least one air parameter (e.g. CO content, CO₂ content, rel. humidity, air pressure, O₂ content, foreign matter content) of the air to be filtered at the filter device and/or an operating parameter of the filter device (e.g. power consumption, air throughput, volume etc.). The sensor element can be arranged upstream of the filter element in order to measure the air parameter before filtering. Additionally or alternatively, the sensor element can be arranged downstream of the filter element in order to measure the air parameter after filtering. Thus, for example, a qualitative and also quantitative filter performance can be determined. In addition, a certain air parameter, in particular before filtering, can provide information about the room state described below, for example whether persons are present in the room.

The sensor element thus measures air parameters such as, for example, a concentration of various air accompanying substances or foreign matters and/or the air quality. The direct measurement of foreign matters or groups of foreign matters in the air flow can be provided by means of the sensor element. This can relate, for example, to the amount of fine dust of a certain diameter class. Further, for example, other foreign matters can be filtered away beforehand so that only the certain air accompanying matters hit the sensor. In the case of turbulences due to turbulent flows of the air through the filter device, heavier matters (particles, molecules, aerosols, etc.) are moved away by centrifugal forces in the radial direction of a flow roller, which leads to a dehomogenization of the air flow composition. The sensor element can be arranged correspondingly spaced apart from a wall of the flow channel of the filter device in order to reduce the influence of the turbulences.

The sensor element comprises, for example, a MEMS sensor. Furthermore, the sensor element can in particular be configured such that the sensor element can be used for a Fourier transform infrared spectrometer analysis FTIR and/or a near infrared spectroscopy analysis. Parameters such as particles per volume can be measured. Furthermore, the sensor element can comprise a resistance sensor for measuring the air accompanying matters and/or the air quality. For example, a trigger substance can additionally be used in order to measure the presence of certain foreign matters in the air (e.g. Bresle measurement).

Accordingly, the further sensor element can be formed like the sensor element described above. The further sensor element is in particular placeable spaced apart from the filter device (in the same room or in another room of the building) and is configured for determining at least one further air parameter (e.g. CO content, CO₂ content, rel. humidity, air pressure, O₂ content, the foreign matter content) of the air at the further sensor element. The further sensor element can, as explained in the exemplary embodiments described below, represent a separate independent sensor element and can be arranged spaced apart from the filter device. The further sensor element can further be installed in a further (e.g. secondary) filter device. Furthermore, the further sensor element can be part of a primary filter device. In particular, a plurality of (secondary) filter devices with corresponding further sensor elements can be arranged and further a plurality of independent and/or further sensor elements arranged in the primary filter plant can be provided.

Furthermore, the filter device comprises the control unit which is coupled to the filter device and to the further sensor element and is configured to determine at least one room state (e.g. CO₂ room distribution, occupancy by persons (persons present/no persons present, distribution of the persons in the room, noise levels in the room etc.) or a filter state (e.g. filter occupancy state, information regarding the necessity of a filter exchange, information regarding the necessity of a ventilation expectation necessary) based on the filter device parameter (i.e. the air parameter of the air to be filtered at the filter device or an operating parameter of the filter device) and the further air parameter.

Due to the spatial distance of the sensor element and the further sensor element, for example, a local distribution of concentrations of the air parameters can be determined. Based thereon, the control unit can make statements, for example of the spatial grouping of persons or statements about the presence and the local presence of a danger source. For example, if the soot load at the further sensor element increases compared to the sensor element, it can be concluded therefrom that a fire source is locally present in the vicinity of the further sensor element. Accordingly, for example, due to a different CO2 concentration at the location of the sensor element compared to the location of the further sensor element, it can be concluded that persons (according to their exhaled air) are more likely to be grouped at the location of the sensor element or at the location of the further sensor element. Furthermore, a filter state (e.g. filter occupancy state, information regarding the necessity of a filter exchange, information regarding the necessity of a ventilation expectation necessary) can be determined based on the measured air quality at the filter device by comparing the air quality at the further sensor element.

The control unit is arranged, for example, in the filter device. For example, the control unit is configured to control the fan unit of the filter device. Additionally or alternatively, the control unit can be coupled to a primary filter plant of a building in order to control the ventilation performance or the filter performance of the primary filter plant. The control unit can be arranged at a central location of the building, in the primary filter plant or in the above-described filter device.

With the filter system according to the invention and the separate sensor measurement of the sensor element and the further sensor element, a room state or a filter state can be determined based on the thereby obtained filter device parameters of the filter device and the further air parameters in order to thereby again obtain information for controlling the overall system, including a primary filter plant or the filter device.

According to a further exemplary embodiment, at least the air parameter or the further air parameter is selected from the group consisting of the CO content, CO2 content, the rel. humidity, the air pressure, the oxygen content, the flow rate of the air, the foreign matter content comprising e.g. foreign matter particles, in particular the fine dust content, particle size of the foreign matter particles, in particular the diameter of the foreign matter particles, foreign matter particle type, the dew point and the air temperature.

According to a further exemplary embodiment, at least the operating parameter of the filter device is selected from the group consisting of the power consumption of the filter device, the air throughput through the filter element, the volume of the fan unit, the flow volume of the through-flowing air and the temperature of the fan unit and the pressure drop of the through-flowing air over the filter element.

By means of the sensor elements, gas contents, liquid contents or solids in the air flow can also be detected and e.g. their chemical/physical properties, in particular quantities and/or (e.g. average) diameters can be determined. Based on these basic measured values, also post-divided calculations can be calculated, such as CO₂ imprint, (energy) saving potential (e.g. depending on the pressure drop over the filter, which can be influenced by the filter material or filter change) or energy consumption. Likewise, by means of an algorithm, measured values can be adapted, standardized or adapted. These measured values can be transmitted wirelessly or in a wire-bound manner to other systems.

According to a further exemplary embodiment, the control unit is configured to determine at least the spatial state which is selected from the group consisting of a CO2 distribution in the room, a presence of persons in the room, a person occupancy in the room, a distribution of the persons in the room, noise levels in the room, a presence and/or a position of a source of danger, in particular a fire source, an aerosol concentration, a fine dust concentration and/or a virus concentration, in the room.

According to a further exemplary embodiment, the control unit is configured to determine at least the filter state which is selected from the group consisting of a filter occupancy of the filter element, a filter replacement indication and a ventilation expectation indication. The control unit can for example determine the filter state based on the filter device parameters, e.g. the operating parameter and the air parameter of the air to be filtered at the filter device. For example, the air throughput through the filter element can be determined and the sensor element can determine the concentration, e.g. of fine dust, before and after the filter element as air parameter. If the filtering of fine dust in relation to the set air throughput at the filter element does not correspond to a setpoint value, a filter occupancy can be concluded and a filter change can be indicated by means of the control unit. Furthermore, in the case of a measured power consumption of the fan unit in relation to an air throughput through the filter element, a defect of the fan unit can be concluded.

According to a further exemplary embodiment, the control unit comprises a display element for displaying the room state and/or the filter state. The display element can for example consist of optical display elements, such as for example LEDs, which display the room state or the filter state by means of a certain shade (German: Farbton). If for example the CO2 content in the room is too high and/or the oxygen content is too low, for example a red LED can be displayed. If the CO2 content is below a limit value, for example a green LED can light up. Correspondingly, for example a free, operable filter state can be displayed with green and an occupied filter state, as a result of which a filter change of the filter element is necessary, can be displayed with red. Furthermore, the display element can form a graphic display, in particular a touch-sensitive display (Touch Display). On a graphic display, for example more complex information, such as for example an image of the room, can be displayed and corresponding regions in which a certain room state or a filter state is present. Thus for example the region in the room can be graphically displayed in which a high CO2 concentration is present and another region in the room in which a lower CO2 concentration is present.

According to a further exemplary embodiment, the further sensor element is arranged in the same room as the filter device. Thus, at several locations in the room corresponding air parameters can be measured in order to cover in particular the entire room as a measuring area. Accordingly, a reliable statement about the exceeding of individual limit values of air parameters in the room can be made.

According to a further exemplary embodiment, the further sensor element is arranged in a different room than the filter device. Accordingly, air parameters from several rooms of a building can be determined or measured. If for example in one room the CO2 content increases compared to another room, for example the occupancy of the room with persons can be determined. Accordingly, for example the primary ventilation system (for example the central ventilation system) or the individual filter devices in one of the rooms can be controlled in order to establish the desired room state in a room. Based on the knowledge of the occupancy of the room via the comparison of the CO2 values in the corresponding rooms, a digital occupancy plan of the rooms can furthermore be controlled by means of the control unit. If for example the CO2 content increases in a room and this corresponds to an occupancy with several persons, this room can be determined as occupied in an occupancy planner. By measuring and evaluating the noise level in a room, the number and intensity of the speech-active persons in the room can be concluded and the ventilation performance can be adapted thereto, since the emission of aerosols by persons increases with the speech volume.

According to a further exemplary embodiment, the filter system comprises a further filter device in the room, spaced apart from the filter device, wherein the further filter device comprises the further sensor element. The further filter device, which comprises the further sensor element, can for example represent a ventilation outlet in a room, wherein the ventilation outlet can represent part of a central ventilation system. The further sensor element is thus part of a further filter device, which is arranged spaced apart from the filter device in the room. The control unit can display the room state of the room in a location-dependent manner based on the measured parameters and further air parameters of the corresponding filter devices. Thus for example a room map can be created in a targeted manner, in which the individual concentrations of the selected air parameters are displayed. Based thereon, in a further exemplary embodiment, the control unit can control the individual filter devices individually in order to adjust the desired concentration of the air parameters in a room based on their filter performance.

According to a further exemplary embodiment, the further filter device comprises a further filter element, wherein the further filter device is in particular a part of a central filter plant of a building. Based on the measured further air parameters, the control unit can for example control the central ventilation system in order to adjust the desired air parameters together with the local filter device located in the room.

According to a further exemplary embodiment, the further filter device comprises a further fan unit and is in particular configured to be movable (e.g. as a mobile secondary filter device). By comparing the individual performance data of the fan unit of the filter device and the further fan unit of the further filter device, the corresponding filter state in the corresponding filter devices can furthermore be concluded in order for example to obtain information about the filter occupancy of the corresponding filter elements.

According to a further exemplary embodiment, the control unit is configured to determine the position data of the filter device and/or of the further sensor element (or of the further filter device) (for example by means of an indoor positioning system, a WLAN or by means of locating the connection point (socket) of the corresponding filter device in the room) and/or to take preconfigured position data into account.

According to a further exemplary embodiment, the control unit is configured to create, based on the position data, a heat map (for the air parameter “temperature” or analogously for other measured values), a local distribution image of a gas concentration, in particular a CO2 concentration distribution (for the air parameter “CO2 concentration”) or O2 concentration distribution (for the air parameter “O2 concentration”), a person distribution (for example calculated air parameters based on the CO2 concentration), an aerosol distribution (for the air parameter “aerosol concentration”), a moisture distribution (for the air parameter “relative humidity”), a virus distribution (for example by means of analysis of corresponding indicators and markers which can be arranged in the filter element), a foreign matter component concentration, e.g. fine dust concentration distribution (for the air parameter “fine dust concentration”). By knowing the position data of the sensor element and the further sensor element, graphic images of a room with corresponding local concentrations of desired air parameters can thus be displayed.

According to a further exemplary embodiment, the control unit is configured to control the filter device, in particular the fan unit, based on the room state and/or the filter state. For example, the control unit can control the filter device and multiple further filter devices. Thus, for example, a plurality of local (mobile) secondary filter devices can be installed in a room and additionally a part of a primary central ventilation system can be provided in the room. Based on the corresponding measured position-related air parameters, the control unit can individually control all filter devices, both the secondary filter devices and the primary filter device. In other words, based on a relation of the measured values of the air parameters to one another, an action (control action) can be triggered and/or an information can be displayed. In particular, one of the filter devices can be controlled and/or regulated, preferably a secondary filter device, which was previously active in the conventional approaches, in particular in island operation.

According to a further exemplary embodiment, the control unit is configured to variably control the filter device, in particular the fan unit, such that this variation shifts the spatial suction area, in particular such that the influence of the variation of the suction area co-determines the determination of the room state. For example, the direction from which an air flow is sucked into the filter device can be controlled. For this purpose, the filter device can comprise, for example, spaced-apart air inlets, through which ambient air can be selectively sucked in. Additionally or alternatively, the filter device can comprise controllable air flaps, which set a suction direction in a targeted manner. The control unit can thus control the suction area from which the air flow is sucked in and accordingly use the suction area for the analysis of the room state and/or the filter state. The measuring location or the suction area is thus changed without the filter device leaving its location. In primary filter devices, the air flow can be set by a flap or valve control at the location of the air suction in the room such that only a certain zone, in particular a room or a certain room region, supplies analysis air for the sensor element. In contrast, a secondary filter device can vary the direction from which air is sucked in by internal mechanisms (e.g. individual fans vary in the output or adjust suction flaps ‘left’ or ‘right’), which in turn enables measured values from different suction areas.

According to a further exemplary embodiment, the control unit is configured to variably control the filter device, in particular the fan unit, such that a future energy availability and/or the current and/or future energy consumption of the filter system and/or of the building can be taken into account. The control unit is in particular configured to automatically or partially automatically with approval function control the filter device based on the future energy availability and/or the current and/or future energy consumption of the filter system and/or of the building and/or regulate it within a predefined range.

Thus, for example, a building part can be cooled down as a precaution (e.g. meeting room at reservation date) if it is known that energy is required for other things (e.g. car charging) at a later point in time. During the energy requirement for other operating states of the building, the cooled region is switched to circulating air and the air quality is monitored in a location-dependent manner so that from a certain reduced quality level of the air (from a certain value of a certain air parameter in the room, for example oxygen content) the charging power is reduced and the ventilation is increased again. With a parameterization, the importance of different air parameters measured by the sensor elements can be weighted and included in the energy consumption decision of the control unit. The control unit can control the filter devices in a fully automatical and self-acting manner, for example. Alternatively, the control unit can control the filter devices in a partially automatic manner and present a recommendation to an operator prior to the execution of critical control decisions, which the operator must agree to (corresponds to the above-mentioned approval function).

According to a further exemplary embodiment, the filter element is configured such that a pressure drop of the through-flowing air through the filter element is less than 450 Pa, in particular less than 250 Pa, further in particular less than 150 Pa. The filter performance of the filter module according to the invention, in particular of the filter region, is measured according to EN ISO 16890, for example, and is better than 50% for one of the classes “ISO Coarse”, “ISO ePM10”, “ISO ePM2,5” or “ISO ePM1”.

According to a further exemplary embodiment, the filter device is configured such that an air volume per hour and square meter of filter area of the filter element is less than 600 m³/(m²×h), in particular less than 140 m³/(m²×h), less than 85 m³/(m²×h) or less than 50 m³/(m²×h), and/or the velocity of the volume flow of the air through the filter device is in the range of 0.1 to 5 m/s, in particular in the range of 0.2 m/s to 3.4 m/s, further in particular between 0.3 m/s to 2.8 m/s.

The filter element according to the invention and in particular the filter material is configured such that at a velocity of the volume flow of 0.1 m/s to 5 m/s through the filter body, the pressure drop of the air which flows through the filter body is less than 450 Pascal. Accordingly, the filter element serves for cleaning large air masses with a low pressure loss. These values can be set structurally in particular by the selection of the filter material and the corresponding pore sizes and fabric structures of the filter material. For the integration according to the invention of the sensor elements in the filter devices, it has been shown that operating data are especially suitable when a volume flow in the filter element is between 0.1 and 5 m/s, in particular between 0.2 and 3.4 m/s, preferably between 0.3 and 2.8 m/s and a pressure drop across the filter element is less than 450 Pa, in particular less than 250 Pa, preferably less than 150 Pa.

When the corresponding filter device is operated within these characteristic values, it can be ensured by the measures proposed according to the invention (or a combination thereof) that the sensor element has hardly any disturbances in the location, i.e. in the entire fluctuation range of the operating data the sensor data match the assigned location range. Also, the composition of the air flow at the sensor element changes only insignificantly with a pressure drop variation of 50 Pa to 450 Pa. The solution according to the invention is suitable above all for filter devices which have a pressure drop across the filter device of less than 500 Pa, since above all the optimizations of the flow resistances according to the invention are taken into account. Especially good results are achieved when in one operating mode less than 450 Pa, in particular less than 250 Pa, preferably less than 150 Pa pressure drop is present in the filter element.

In addition, it has been recognized that the limitation of the pressure drop across the filter element by a filter area overdimensioned according to the invention (e.g. by the wave-shaped integration of the filter membrane between two fleeces described below) makes it possible to correspondingly reduce the volume flow per time and area. Thus, during operation of the filter device air volume quantities per hour and square meter of filter area (i.e. a so-called filter area load) of less than 600 m³, in particular less than 450 m³ or 140 m³, preferably less than 85 m³, especially preferably less than 50 m³ are possible. This leads at the same time to a less rapid occupancy of the filter element and as a result to smaller pressure drop differences across the filter element.

According to a further exemplary embodiment, the control unit is arranged separately from the filter device and the further sensor element. The control unit can exchange signals with the filter devices and the corresponding sensor elements in a wire-bound or wireless manner, for example. Furthermore, the control unit can exchange corresponding signals with the fan units.

According to a further exemplary embodiment, the control unit is configured to determine an energy consumption of the filter device based on the determined room state and/or the determined filter state. Additionally or alternatively, the control unit is configured to determine control data for the filter device, in particular for the fan unit, based on the determined room state and/or the determined filter state and to display these to a user and/or to automatically control at least one filter device, preferably multiple, in particular all filter devices, by means of the control data.

Thus, the control unit can generate data on the energy consumption and/or on the CO2 footprint of the filter system and/or of the filter device. A filter device and in particular its filter element requires more and more energy for the intended use with increasing occupancy, since the pressure difference across the filter increases due to the filter occupancy. The control unit can furthermore obtain data on energy costs or on a CO2 footprint of the filter element due to its manufacture. The control unit is configured to determine and display a recommendation with respect to optimal filter change time (or cleaning time) of the filter element based thereon. In particular, individual parameters such as energy costs, saving potential, CO2 savings, CO2 certificate costs can be generated by means of the control unit.

According to a further exemplary embodiment, the control unit is configured to analyze the room state based on the determined foreign matter content or fine dust as air parameter, in particular based on the frequency of occurrence of the fine dust, in particular a frequency of diameter classes of the fine dust and/or the composition of the fine dust, in particular in real time. For example, an additionally reduced flow rate (with small pressure drop across the filter) in turn leads to a more homogeneous air flow guidance and to less turbulent air turbulences (which e.g. force fine dust particles radially away). This makes it possible to carry out measurements which provide a relation to the fine dust composition (diameter, quantity, substance analysis, etc.). The control unit is configured to carry out real-time analyses with respect to a fine dust load.

According to a further exemplary embodiment, the control unit is coupled to the filter device and/or to the further sensor element for wireless signal exchange of sensor signals or control commands, wherein the filter device provides filter-related data to the control unit, in particular by means of RFID, NFC, Bluetooth, WLAN or protocols of building control technology, wherein the control unit is in particular configured such that a warning signal can be generated on the basis of the filter-related data and/or a measure can be taken which relates to a throughput through the filter device. The filter device and the control unit may respectively comprise an antenna or a conductor-based system which signals the readiness of the filter system to exchange data. Such data may relate not only to parameters relating to the air accompanying matters of the air, but also contain information and details of the filter device. Thus, for example, depending on the performance of a filter device used, the air volume can be adapted by the filter device or the filter system. Furthermore, when a runtime or occupation density of the filter element is exceeded, a signal can be emitted which can either be interpreted as a maintenance signal or can also be used as a control signal in order to reduce the air throughput quantity. An embodiment variant of a transmitting device in the filter device and/or the control unit may be an RFID transponder (which for example also comprises filter data in encrypted form). Furthermore, other communication mechanisms such as NFC, Bluetooth, WLAN, etc. can also be used. For wire-bound communication, in addition to proprietary protocols, bus systems of building control systems (LON, EIB, etc.) are also available.

According to a further exemplary embodiment, the control unit obtains a UniqueID from the filter device, wherein the UniqueID comprises information relating to the location of use of the filter device, wherein the control device receives the UniqueID via NFC, Bluetooth, WLAN, proprietary protocols or protocols of building control systems, in particular LON or EIB. The operation and/or the configuration of the filter device can be set based on the UniqueID. In a further especially preferred embodiment, the UniqueID comprises information regarding the installation location of the filter device in the filter system. This ID allows the operating parameters required for the specific operation to be preselected or stored data of a system configuration to be retrieved from a preconfigured operating mode of the filter system or of the filter device. In particular when using encrypted protocols, a new configuration can thus be avoided during the filter change and a ‘plug and play’ can be realized. Corresponding data can be transmitted from the filter system or the filter device during the change or can be transferred via cloud. The transmission of the UniqueID to the filter system can be carried out using mechanisms known to the person skilled in the art using QR code, barcode, OCR fonts (and their successors for machine-readable fonts), RFID, NFC, Bluetooth, WLAN, proprietary protocols or protocols of building control systems (LON, EIB, etc.). By means of this mechanism, it is also possible to deliver a filter system or a filter device, in which functions are only enabled if a part of the UniqueID belongs to the agreed delivery scope. By means of this mechanism, it is also possible to deliver a filter system, in which functions are only enabled if a part of the UniqueID belongs to the agreed delivery scope.

According to a further exemplary embodiment, the filter element comprises a filter material which contains one layer of fleece, in particular multiple layers of fleece, wherein the filter element is exchangeably arrangeable in the filter device. The filter element is, for example, a disposable filter. A fleece consists of fibers of limited length, continuous fibers (filaments) or cut yarns, which are joined together and connected to form a fleece (a fiber layer, a fiber web). By means of the interlinking of the fibers, an air-permeable material with narrow, small-pore air passages is provided, as a result of which a good filter effect, in particular of air particles, is achieved.

Since an exchangeable filter element (in particular as a disposable filter) does not have to be adapted exactly to the surrounded housing of the filter device, it is furthermore advantageous if the filter module prevents possible air resonances. In the case of filter materials of regularly arranged filter medium (for example woven, punched, etched or drilled filters), there is the possibility that resonances and thus negative effects arise as a result of self-organizing effects of the air flow (noises, detachment of already embedded pollutants, in particular during start-up and stop of the installation, in the case of variance of physical measured values, etc.). It has been shown that in the solution according to the invention, the use of one layer of a fleece damps this vibration effect. This damping arises as a result of fibers being deposited and brought into adhesion irregularly and randomly. This irregularity reduces the vibration-related self-organization potential. This damping can be increased when using multiple fleece layers in the construction of the filter material, in particular if these comprise at least slightly different fleece materials or fleece layers. A difference can be produced by the manufacture of fleece materials.

According to a further exemplary embodiment, the filter element comprises at least two fleece layers and a filter membrane arranged between the fleece layers, which are arranged in a layered manner one above the other in a layered composite, wherein in particular the middle filter membrane of the layered composite has a larger surface area than the two outer fleece layers.

According to a further exemplary embodiment, a first direction and a second direction span a plane, wherein the middle filter membrane is configured to be corrugated with corrugation sections such that the corrugation sections are arranged one behind the other along a first direction. The corrugation sections run irregularly and asymmetrically to one another in particular within the plane. The filter element is arranged such that air is flowable over the filter element along the first direction or along the second direction.

For example, the x direction is the air inflow direction of the air and the corrugation sections run transversely to the first direction along the second direction. The asymmetry of the corrugation arrangement and shape can be used for vibration damping. Alternatively, the filter body can also be flowed against in the Y direction and thus parallel to the extent of the corrugations. The corrugation sections thus form, for example, a shark skin-like riblet structure which brings about a reduction in the flow resistance. Depending on the entry conditions (inflow cross section, volume flow, depth of the filter material to be flowed through) into the filter element, the one or other configuration can be especially advantageous. The asymmetry of the corrugation arrangement can be achieved by a self-organizing compaction process in which the feed rate of the filter membrane is significantly higher than the feed rate of the two cover fleeces. The asymmetry of the corrugation arrangement arises as a result of thermal fixing of the three layers at a predetermined point in time. In addition to the advantages already described, this asymmetry has a stabilizing effect on deflections in the x-y plane.

The filter membrane is accumulated in a corrugation shape and, for stabilization, connected at the top and bottom to a cover fleece (adhesively bonded, welded, stapled, etc.). Thereby, it is ensured that, during the lifetime of the filter element, enough open membrane region is provided and that they do not lay down in a flat manner or fold under occupation and thus additionally reduce the through opening.

According to a further exemplary embodiment, the filter element has a thickness of 2 mm to 10 mm, in particular of 3 mm to 7 mm, and/or the number of corrugation sections is between 0.5 and 3 corrugations per cm.

This allows a filter performance similar to a HEPA filter, but with a pressure drop in the region of a normal F7 filter (i.e. within the operating parameters of the solution according to the invention).

According to a further exemplary embodiment, the filter element comprises a filter material which is hydrophobic and/or contains a natural fiber or a polyolefin, in particular a polypropylene, in particular that the filter contains cellulose, cotton and/or hemp. If the air flow to be filtered is loaded with a high aerosol load, known filters can have a tendency to soak. On the one hand, this can statically increase the pressure drop across the filter, but also dynamically, due to the very rapidly changing pressure conditions, overcharge a subsequent volume flow regulation by means of VAV in the sense of its regulation rate. The solution according to the invention can solve this problem by a suitable material selection of the filter material: either a hydrophobic material (e.g. a polyolefin, in particular polypropylene, which is substantially free of polar groups) or an absorbent material with a special (for example deep) tendency to swell (e.g. a natural fiber, in particular a cellulose fiber, cotton or hemp) is used. Thus, the tendency of filling filter openings with micro- or nanoscale water droplets is reduced. It has been shown that the fungicidal, virucidal and bactericidal properties of hemp are favorable and make it an ideal filter component. This reduction in the pressure drop also leads to less location-unstable measurements (i.e. in the case of a smaller pressure drop, more air is sucked through and therefore a larger location map is relevant for the measured values than is expected in the assessment as a composite).

According to a further exemplary embodiment, the filter device comprises a weighing device which is configured to weigh the filter occupancy of the filter element, in particular that a measured value falsification by the pressure of the air flowing through the filter device can be compensated. With corresponding additional mechanisms, a compensation of the measured value falsification by the pressure of the air resistance can be achieved during the operation of the filter device. This also allows the determination of a high filter occupancy of the filter element for an operating mode of the filter device at a low volume flow which does not lead to the triggering of the differential pressure monitoring of the filter element in conventional filter monitoring. In particular in secondary filter plants, efforts are made to work with low pressure differences so that the noise level remains low. This detail allows a reliable measurement of the filter occupancy despite very low pressure differences. In particular, the weighing device can have a ground contact in the installed state of the filter element in the housing of the filter device and thus introduce the weight force of the filter element to the ground. As a result, a weight measurement of the filter element can be carried out.

According to a further exemplary embodiment, the filter device comprises an electrical supply unit which is configured to obtain energy by means of the air flow through the filter device and/or by electromagnetic waves, which energy is used in particular for operating the sensor device and/or the filter device. It may be expedient for the sensor system to be configured autonomously in terms of energy so that the filter system receives measurement data, or such data can be displayed at times when the secondary filter plant or the filter device is out of operation. This can be realized both by means of a live-time battery or by means of a supply by energy harvesting. In this case, it is expedient to use sensor elements which save as much energy as possible. Additionally, the energy consumption can be reduced with changing the duty cycle, i.e. the sensor element is not operated permanently, but rather cyclically only during a 1/10 or 1/100 (or even shorter measurement intervals) of the time. If the measurement speed of the sensor element is high (that is to say the time for a measurement is short), an exact or even highly exact measurement nevertheless takes place owing to the inertia with respect to changes in the air flow composition. Energy-saving sensor elements are increasingly smaller and smaller, which in turn leads to difficulties in the placement in the air flow and in ensuring the targeted flow around. These increasingly miniaturized sensor elements allow two, three or more than 3 different sensor elements to be integrated in the filter device.

In particular, it has been shown that the use of combination sensors which determine multiple air parameters with one sensor element is especially advantageous, because only the air flow continuity at a specific location has to be ensured for this purpose, and with this effort, multiple air parameters are then available. Such an autonomous solution is also advantageous in particular for the retrofit of existing filter devices or the supplementation of foreign filter systems.

The electrical supply unit can be configured to obtain energy by means of the air flow through the filter module and/or by electromagnetic waves, which energy is used in particular for operating the sensor element. For example, energy can be obtained via the pressure difference across the filter element, e.g. by means of a propeller, galloping harvester, piezoelectric flags (piezo element) and/or by receiving and rectifying a high-frequency oscillation (e.g. from a WLAN router). This energy is used for the operation of the sensor elements.

According to a further exemplary embodiment, the filter system comprises a data storage unit which is coupled to the control unit, to the filter device and to the further sensor element for exchanging data. In particular the data can be protected by means of a certificate and/or an encryption, wherein in particular the data represent measured values selected from the group consisting of air throughput through the filter device, air temperature, air pressure, in particular absolute pressure and/or differential pressure, filter occupancy of the filter element, humidity, aerosol loading, PM content and/or foreign matter content of the air, measuring location of the air measurement. First of all in the case of especially demanding operating conditions, it may be of interest that individual detection details can be stored and parameterized. On the one hand, this relates to details of the measurement method, on the other hand also details about the recorded air parameter or filter device parameter (e.g. air throughput, temperature, pressure (in particular absolute pressure and/or differential pressure), filter occupancy, humidity, aerosol loading, PM content [in particular also how much of which diameter class]. Such a data record can then in turn be transmitted by means of a communication, or read out only after the end of the filter service life.

According to a further exemplary embodiment, the sensor element is a dynamic pressure gauge and is in particular configured such that a static pressure upstream of the filter element and a static and dynamic pressure downstream of the filter element can be measured. If the velocity of the air flow is high enough, then the differential pressure between a normal pressure tap upstream of the filter body and a dynamic pressure pipe (or Pitot pipe) downstream of the filter can be measured. The pressure at the Pitot pipe is given by the sum of the static pressure and the dynamic pressure and is therefore higher than at the normal pressure tap upstream of the filter. This configuration creates an inverted or negative differential pressure across the filter and allows clogged supply lines or flap disturbances to be detected. This embodiment can be suitable in particular for retrofitting older installations. By using a controller in the filter module or filter system, it becomes possible to parameterize the response and/or limit values in the filter system from the outside.

The sensor element can for example comprise a microphone and detect the noise level in the room as well as in particular the location of the noise source. By measuring and evaluating the noise level in a room, the number and intensity of speech-active persons in the room can be concluded and the ventilation performance of the fan unit can be adapted thereto via the control unit, since the emission of aerosols by persons increases with the speech volume. In other words, the regulation of the ventilation performance can thus be set via the noise level in the room. The more persons speak, or speak loudly, the more aerosols are emitted and the higher the fan performance can be, since then e.g. the additional sound of the devices, such as e.g. the fan unit, is not perceived and does not disturb. If one or more persons sit still in the room, the ventilation performance goes down, because it must be quiet for concentrated work, wherein however also hardly any aerosols are emitted.

According to a further aspect, a building is described with a plurality of rooms and a filter system described above. The filter system comprises a central ventilation system (primary ventilation system) which comprises at least one further fan unit and in each case one ventilation outlet in the corresponding rooms. The control unit is configured to control the further fan unit, wherein the control unit controls the filter device and/or the central ventilation system based on the room state and/or the filter state.

In summary, in particular by means of the control unit, an interaction of secondary ventilation devices, such as the filter device, can be provided for optimizing the energy consumption, the aerosol depletion, the operating costs or the CO₂ imprint of the filter system. Also a based thereon recommendation for the filter change from environmental protection considerations instead of the decision on the basis of the pure filter occupancy or operating time can be provided with the solution according to the invention.

A control of a secondary ventilation or of the filter device by means of the control unit can take local system loads and local noise emissions into account by communication with other filter devices of the filter system (for example a further filter device or a primary filter unit) in such a way that the noise level is reduced despite high air cleaning. Also by means of the control unit and by means of the separate local arrangement of the sensor element and the further sensor element, a visualization of the location-dependent air load in the room based on the combination of measured values of the air parameters of secondary/primary ventilation devices can be enabled.

The present invention relates for example to a secondary filter device which communicates with other filter devices (other primary and secondary filter plants, display systems, controls) and based on measurement data relating to air and filter load provides information electronically or visually, proposes measures or automatically executes measures.

Normally secondary ventilation devices only display the air parameters or the filter device parameters. Especially in the interaction of multiple such filter devices it is present according to the invention to network the filter devices among one another and/or in connection with a primary filter device so that optimizations can be carried out, in particular automatically. According to the invention in other words, a filter system is provided which controls, regulates or visualizes decentralized filter devices (secondary filter devices) (in particular also heterogeneous) in the network (in particular in interaction with primary) filter device.

Thus, according to the invention multiple filter devices are coordinated for air cleaning. These can be primary and secondary filter devices, wherein at least one (secondary) filter device can supply precise measurement data relating to the air parameters in the room, in particular for exactly one location range, such as the air quality or supplementary measured values in the range. This is advantageous in particular when within a delimited range it has to be decided which ventilation measures are to be preferred (at best automatically). According to the invention, various ventilation measures can be taken in order to achieve the following goals, such as, for example,
aerosol depletion up to a certain level
CO2 reduction
energy optimization of individual filter devices or of the entire filter system
reduction of the CO2 footprint of a filter system
recommendations for the filter change
temporal energy optimization (e.g. in cooperation with demand side management with respect to electrical energy supply), in particular control/consideration of maximum load, maximum energy consumption, band energy, charging and feedback of eMobiles on the building, etc.
reduction of acoustic noise
adaptation of the ventilation performance to the noise level in the room
optimization of the operating parameters of the filter devices taking into account the grey energy which is or has been required for installed hardware and consumables.
prioritization and combination of target values, at best weighted according to importance or with definition of one or multiple target bandwidths (recommendations for the filter change, based on exposure details and further parameters such as CO footprint, minimum air quality, etc.)

The control unit can control the filter devices based on the locally measured air parameters such that the following action options can be implemented:
automatically more ‘ventilate’ in occupied meeting rooms or rooms. If a filter device is installed as a secondary filter plant in a room, an optimization can be optimized with respect to multiple target values or air parameters.
A filter device as a primary filter system can comprise an integrated cooling system (central air conditioning system) and be reduced in terms of performance by means of the control unit, during which a further filter device as a secondary filter device is increasingly activated in a room. This leads to an energy saving without deteriorating the room air quality (or vice versa if the secondary filter system is coolable).
At high outside air temperatures, the room temperature can be increased by external air supply of the filter device as a primary filter plant above a comfort temperature in the room. This can be counteracted automatically in that the external air supply primary filter device is throttled and the secondary filter devices are increasingly activated in the individual rooms in the circulating air mode (in particular in school(s) and/or meeting rooms).
realization of target specifications (e.g. by means of learning systems) taking into account stored historical measurement data of the sensor elements (e.g.
   if the first derivation of the CO2 level as an air parameter has a certain magnitude, an excessively high CO2 level can be expected promptly, as a result of which a preventive start-up of the filter devices can be initiated by means of the control unit in order then not to require an excessive maximum ventilation mode of the fan unit during the high loading with CO₂ in the room and accordingly to have a lower noise level in the room).
In many occupied school—and/or meeting rooms, it can be energetically better to start the primary filter device, for example a central filter plant (RLT), than to start all secondary filter devices, since a central ventilation system (with corresponding design) can work in an energy-efficient manner on account of the larger fans.
By means of the control unit and the processing of the data of the sensor elements, permanent and continuous optimization of energy consumption and CO2 footprint, for example in real time, can be carried out. Thus, it can be advantageous, for example, to exchange a filter element before the end of life, since an exponentially rising pressure drop occurs across the filter element as a result of the filter occupancy within the framework of the service life. Depending on energy costs or requirements on the CO2 footprint of the filter system, a filter change before the steep rise of the differential pressure can still contain a cost or result improvement within the service life of the filter element.

Furthermore, the filter system according to the invention encompasses an embodiment in which, for example, also only two secondary filter devices are arranged in a room (e.g. meeting room) if a fan performance is increased or reduced by the communication of the measurement values of the air parameters or of the filter device parameters of these filter devices by means of the control unit. In particular in the presence of multiple spatially resolved measured values, a measurement value representation, e.g. as a heat map, can be carried out. This also allows conclusions to be drawn on local sources of emissions such as e.g. fine dust.

It is pointed out that the embodiments described here merely represent a limited selection of possible embodiment variants of the invention. Thus, it is possible to combine the features of individual embodiments with one another in a suitable manner, so that for the person skilled in the art with the embodiment variants explicit here, a plurality of different embodiments are to be regarded as obviously disclosed. In particular, some embodiments of the invention are described with device claims and other embodiments of the invention with method claims. However, the person skilled in the art will immediately understand when reading this application that, unless explicitly stated otherwise, in addition to a combination of features belonging to a type of inventive subject matter, an arbitrary combination of features belonging to different types of inventive subject matter is also possible.

### BRIEF DESCRIPTION OF THE DRAWINGS

In the following, exemplary embodiments are described in more detail with reference to the attached drawings for further explanation and for a better understanding of the present invention.

FIG. 1 shows a schematic representation of a room of a building with a filter system according to an exemplary embodiment of the present invention.

FIG. 2 shows a schematic representation of a building with two rooms and a filter system according to an exemplary embodiment of the present invention.

FIG. 3 shows a schematic representation of an aerosol distribution in a room of a building with a filter system according to an exemplary embodiment of the present invention.

FIG. 4 shows a schematic representation of a filter element with a dynamic pressure gauge according to an exemplary embodiment.

FIG. 5 shows a schematic representation of a filter material for the filter element according to an exemplary embodiment.

FIG. 6 shows a schematic representation of wave shapes of the filter material according to an exemplary embodiment.

### DETAILED DESCRIPTION OF EXEMPLARY EMBODIMENTS

Identical or similar components in different figures are provided with identical reference numerals. The representations in the figures are schematic.

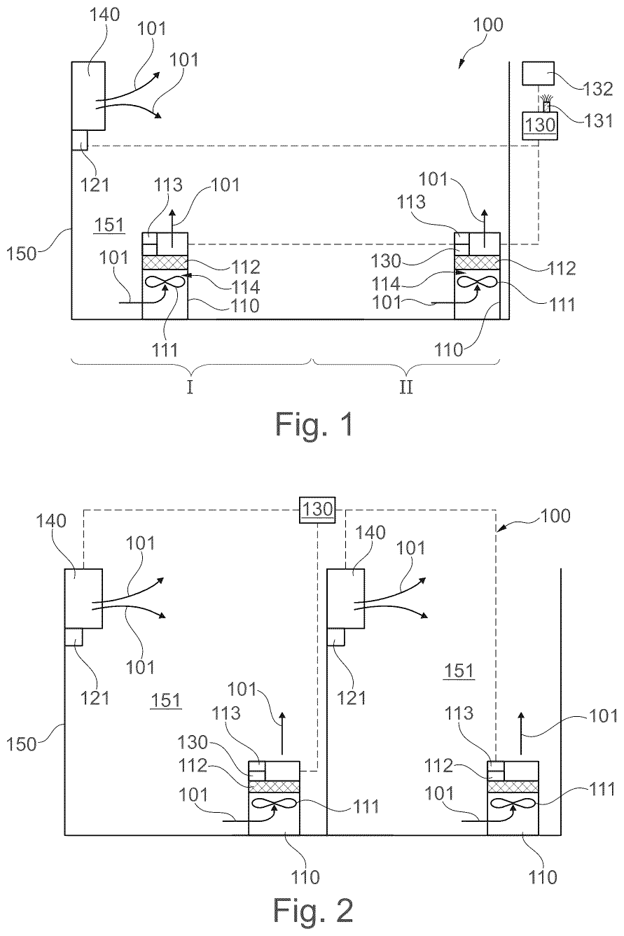

FIG. 1 shows a room 151 of a building 151 with a filter system 100 for filtering air 101 in rooms 151 of a building 150. The filter system 100 comprises a filter device 110 comprising a fan unit 111 and a filter element 112 which is placeable in a room 151, wherein air 101 to be filtered is flowable by means of the fan unit 111 through the filter element 112 for filtering. The filter device 110 comprises a sensor element 113 for determining at least one filter device parameter comprising at least one air parameter of the air 101 to be filtered at the filter device 110 or an operating parameter of the filter device 110. Furthermore, the filter system 100 comprises a further sensor element 121 which is placeable spaced apart from the filter device 110 and is configured for determining at least one further air parameter of the air 101 at the further sensor element 121. The filter device 110 further comprises a control unit 130 which is coupled to the filter device 110 and to the further sensor element 121 and is configured to determine at least one room state or a filter state based on the filter device parameter and the further air parameter.

In the exemplary embodiment shown in FIG. 1, the filter system 100 comprises in particular filter devices 110 which are configured as secondary filter plants and are arranged spaced apart in the room 151. The filter devices 110 are correspondingly arranged at certain locations in the room 151 and are configured, for example, as mobile filter devices 110.

The respective filter device 100 comprises, for example, a housing in which a filter element 112 is arranged or a plurality of filter elements 112 are arranged in series along the flow direction of the air 101 through the filter device 100 or parallel to the flow direction. The filter element 112 can be exchangeably provided.

The fan unit 111 of the respective filter device 110 in particular sucks air 101 to be filtered into the filter device 110 so that the air 101 flows through the filter element 112.

The sensor element 113 of the respective filter device 100 is configured to determine at least one filter device parameter consisting of at least one air parameter (e.g. CO content, CO₂ content, rel. humidity, air pressure, O₂ content) of the air 101 to be filtered at the filter device and/or an operating parameter of the filter device 110 (e.g. power consumption, air throughput, volume etc.). The sensor element 113 can be arranged upstream of the filter element 112 in order to measure the air parameter before filtering. Additionally or alternatively, the sensor element 113 can be arranged downstream of the filter element 112 in order to measure the air parameter after filtering.

Accordingly, the further sensor element 121 can be formed like the sensor element 113 described above. The further sensor element 121 is in particular placeable spaced apart from the secondary filter devices 110 and is configured for determining at least one further air parameter (e.g. CO content, CO₂ content, rel. humidity, air pressure, O₂ content) of the air 101.

For example, the room 151 comprises an air inlet and/or air outlet as part 140 of a primary filter device, for example a central filter plant. The further sensor element 121 is arranged on the part 140 of the primary filter device or can be part of a further secondary filter device in order to correspondingly measure the air parameters.

Furthermore, the filter device 110 or the filter system 100 comprises the control unit 130 which is coupled to the filter devices 110 and to the further sensor element 121 and is configured to determine at least one room state (e.g. CO₂ room distribution, foreign matter content, occupancy by persons (persons present/no persons present, distribution of the persons in the room, noise levels in the room etc.) or a filter state (e.g. filter occupancy state, information regarding the necessity of a filter exchange, information regarding the necessity of a ventilation expectation necessary) based on the filter device parameter (i.e. the air parameter of the air 101 to be filtered at the filter device 110 or an operating parameter of the filter device 110) and the further air parameter.

Due to the spatial distance of the sensor element 113 and the further sensor element 121, for example, a local distribution of concentrations of the air parameters can be determined. Based thereon, the control unit 130 can make statements, for example of the spatial grouping of persons or statements about the presence and the local presence of a danger source.

The control unit 130 is arranged at a central location of the building 150 in the exemplary embodiment from FIG. 1. The control unit 130 is configured to control the respective fan unit 111 of the filter devices 110. Additionally, the control unit 130 is coupled to the primary filter plant 140 of the building 150 in order to control the ventilation performance or the filter performance of the primary filter plant 140.

With the filter system 100 according to the invention and the separate sensor measurement of the sensor element 113 and the further sensor element 121, a room state or a filter state can be determined based on the thereby obtained filter device parameters of the filter device 110 and the further air parameters in order to thereby again obtain information for controlling the overall system, including a primary filter plant 140 and the filter devices 110.

These measured values of the sensor elements 113, 121 as well as the control signals for the filter devices 110, 140 can be transmitted wirelessly or in a wire-bound manner between the control unit 130.

By means of the sensor data of the sensor elements 113, 121, the control unit can determine the room state which is selected from the group consisting of a CO2 distribution or foreign substance distribution in the room 151, a presence of persons in the room 151, a person occupancy in the room 151, noise levels in the room 151, a distribution of the persons in the room 151, a presence and/or a position of a source of danger, in particular a fire source, an aerosol concentration, a fine dust concentration and/or a virus concentration, in the room 151.

The control unit 130 comprises a display element 131 for displaying the room state and/or the filter state. The display element 131 can for example consist of optical display elements, such as for example LEDs, which display the room state or the filter state by means of a certain shade.

Based on the measured air parameters, the control unit 130 can for example also control the central ventilation system 140 in order to adjust the desired air parameters together with the local filter devices 110 located in the room.

At multiple locations in the room 151 corresponding air parameters can be measured in order to cover in particular the entire room 151 as a measuring area. Accordingly, a reliable statement about the exceeding of individual limit values of air parameters in the room 151 can be made.

The control unit 130 is correspondingly configured to determine the position data of the filter devices 110 and/or of the further sensor element 121 (or of the central ventilation system 140) (for example by means of a GPS sensor or by means of locating the connection point (socket) of the corresponding central ventilation system 140 in the room 151) and/or to take preconfigured position data into account.

The control unit 130 can control the filter devices 110 and the central ventilation system 140. Thus, for example, a plurality of local (mobile) secondary filter devices 110 can be installed in a room 151 and additionally a further filter device can be provided in the room 151 as part 140 of a primary central ventilation system. Based on the corresponding measured position-related air parameters, the control unit 130 can individually control all filter devices, both the secondary filter devices 110 and the primary filter device 140.

The corresponding filter device 110 comprises a weighing device 114 which is configured to weigh the filter occupancy of the filter element 112, in particular that a measured value falsification by the pressure of the air flowing through the filter device 110 can be compensated. With corresponding additional mechanisms, a compensation of the measured value falsification by the pressure of the air resistance can be achieved during the operation of the filter device 110. This also allows the determination of a high filter occupancy of the filter element 112 for an operating mode of the filter device at a low volume flow which does not lead to the triggering of the differential pressure monitoring of the filter element 112 in conventional filter monitoring.

The filter system 100 furthermore comprises a data storage unit 132 which is coupled to the control unit 130, to the respective filter device 110 and to the further sensor element 121 for exchanging data.

FIG. 2 shows a schematic representation of a building 150 with two rooms 151 and a filter system 100 according to an exemplary embodiment of the present invention. The filter system 100 from FIG. 2 comprises the same features as the filter system 100 from FIG. 1, wherein the control unit 130 obtains measured values from sensor elements 113, 121 from one room 151 and corresponding measured values from sensor elements 113, 121 from another room 151. Accordingly, air parameters from multiple rooms 151 of a building 150 can be determined or measured. If for example in one room 151 the CO2 content increases compared to another room 151, for example the occupancy of the room 151 with persons can be determined. Accordingly, for example the primary ventilation system 140 (for example the central ventilation system) or the individual filter devices 110 in one of the rooms 151 can be controlled in order to establish the desired room state in a room 151. Based on the knowledge of the occupancy of the room 151 via the comparison of the CO2 values in the corresponding rooms 151, a digital occupancy plan of the rooms 151 can furthermore be controlled by means of the control unit 130.

A building 150 can thus comprise a plurality of rooms 151 and a filter system 100 described above. The filter system 100 comprises a central ventilation system 140 (primary ventilation system) which comprises at least one further fan unit and in each case one ventilation outlet in the corresponding rooms 151. The control unit 130 is configured to control the further fan unit, wherein the control unit 130 controls the filter device 110 and/or the central ventilation system 140 based on the room state and/or the filter state.

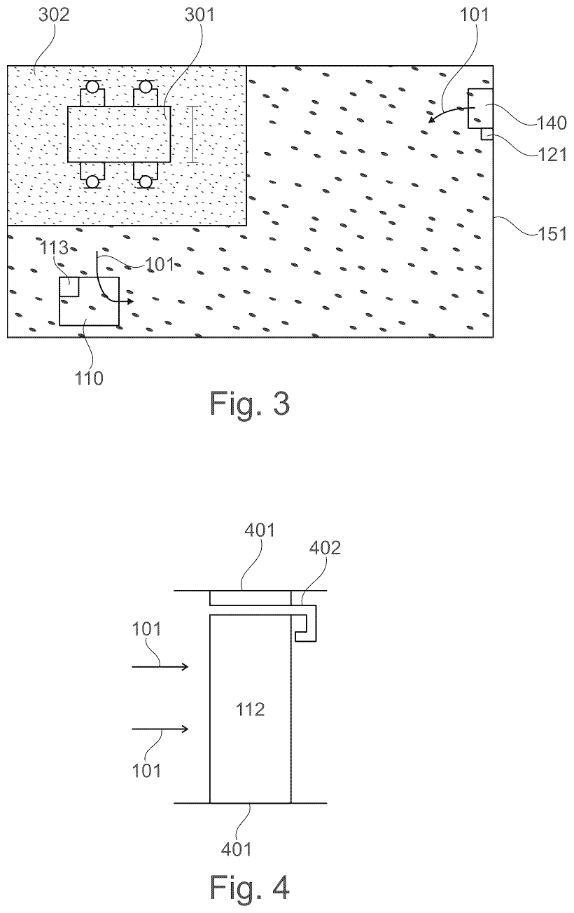

FIG. 3 shows a schematic representation of an aerosol distribution in a room 151 of a building 150 with a filter system 100 according to an exemplary embodiment of the present invention.

Due to the spatial distance of the sensor element 113 and the further sensor element 121, for example, a local distribution of concentrations of the air parameters can be determined. Based thereon, the control unit 130 can make statements, for example of the spatial grouping of persons or statements about the presence and the local presence of a danger source. In the example shown, the aerosol concentration 302 is displayed as an air parameter. In a first room region I, in which a conference table 301 is arranged, there is a higher density of persons, while in a second room region II there are no persons. The concentration of the persons in the first room region I is determined for example by the measurement of the aerosol concentration by means of the sensor element 113 and the further sensor element 121. In this case, the filter device 110 does not have to be located in the first room region I itself. Due to the position data of the filter device 110, it is known that it is located closer to the first room region I than the further sensor 121, for example in a part 140 of a central filter plant. Further, it is known for example that the filter device 110 sucks in the air 101 from a certain suction direction, which points in the direction of the first room region I. Based on these parameters and data, the control unit 130 can determine a corresponding distribution of the aerosol concentration 302 in the room 151.

Furthermore, the display element 131 can form a graphic display, in particular a touch-sensitive display (Touch Display). On the graphic display, an image of the room 151 is displayed and corresponding room regions I, II, in which a certain room state or a filter state is present, are displayed. Thus for example the room region I can be graphically displayed in which a high aerosol loading is present and another room region II in which a lower aerosol loading is present.

The control unit 130 can thus display the room state of the room 151 in a location-dependent manner based on the measured air parameters of the corresponding filter devices 110, 140. Thus for example a room map can be created in a targeted manner, in which the individual concentrations of the selected air parameters are displayed. Based thereon, the control unit 130 controls the individual filter devices 110, 140 individually in order to adjust the desired concentration of the air parameters in a room 151 based on their filter performance.

In FIG. 3, the aerosol distribution is used as an air parameter by way of example. According to the invention, a plurality of other air parameters can be used which can be graphically displayed in a location-dependent manner by means of the control unit 130 and based thereon the filter devices 110, 140 can be controlled.

FIG. 4 shows a schematic representation of a filter element 112 with a dynamic pressure gauge 402 as a sensor element 113, 121 according to an exemplary embodiment. The dynamic pressure gauge 402 is configured such that a static pressure upstream of the filter element 112 and a static and dynamic pressure downstream of the filter element 112 on the exhaust air side can be measured. If the velocity of the air flow is high enough, then the differential pressure p1-p2 between a normal pressure tap upstream of the filter element 112 (pressure p1) and a dynamic pressure pipe (or Pitot pipe) downstream of the filter element 112 (pressure p2) can be measured. The pressure at the Pitot pipe is given by the sum of the static pressure and the dynamic pressure and is therefore higher than at the normal pressure tap upstream of the filter element 112. This configuration creates an inverted or negative differential pressure across the filter element 112 and allows clogged supply lines or flap disturbances to be detected.

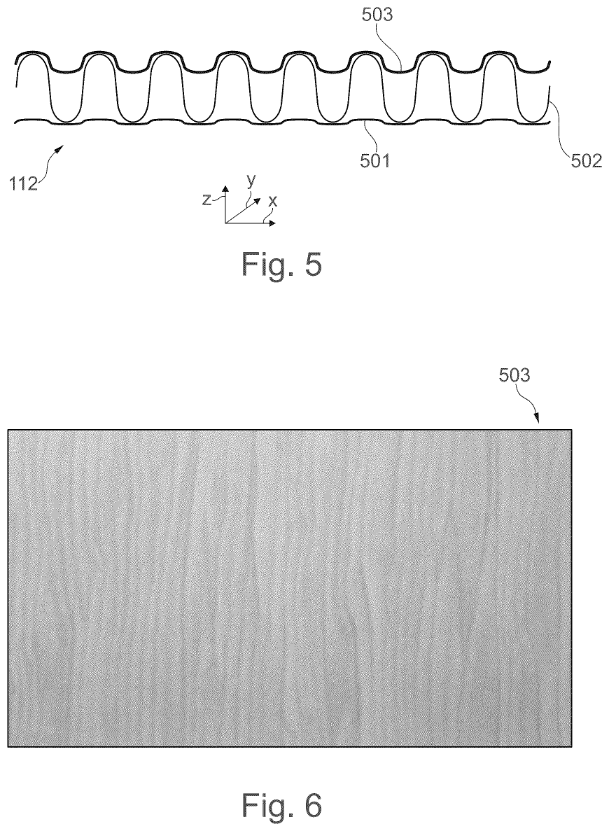

FIG. 5 shows a schematic representation of a filter material for the filter element 112 according to an exemplary embodiment. The filter element 112 comprises in particular multiple filter layers which are arranged one behind the other in the flow direction of the air 101 through the filter element 112, wherein in particular the first filter layer facing the supply air side filters coarser than at least one of the second filter layers following the subsequent first filter layer in the flow direction. Thus, initially coarser particles can be filtered, while smaller particles flow through the first layers and are filtered out only later at the finer layers.

The filter body 112 comprises at least two fleece layers 501, 503 and a filter membrane 502 arranged between the fleece layers 501, 503, which are arranged in a layered manner one above the other in a third direction z in a layered composite, wherein in particular the middle filter membrane 502 of the layered composite has a larger surface area than the two outer fleece layers 501, 503. The middle filter membrane 502 comprises corrugation sections which are arranged one behind the other along a first direction x.

In other words, on the supply air side a coarse cover fleece can be provided as outer fleece layer 503, which is arranged in particular corrugated on the supply air side of the filter membrane 502. Likewise, on the exhaust air side a coarse cover fleece can be arranged as fleece layer 501 on the exhaust air side of the filter membrane 502. The outer fleece layer 503 on the supply air side is corrugated more strongly than the outer fleece layer 501 on the exhaust air side. The filter membrane 502 is strongly corrugated and correspondingly also configured to be strongly filtering. The intermediate region between the outer fleece layers 501, 503 and the corrugations of the filter membrane 502 can be filled with a film material in order to achieve a higher stability.

FIG. 6 shows a schematic representation of wave shapes of the filter element 112 according to an exemplary embodiment.

The corrugation sections run irregularly and asymmetrically to one another in particular within the plane. The filter element 112 is arranged such that air 101 is flowable over the filter element 112 along the first direction x or along the second direction y. For example, the x direction is the air inflow direction of the air 101 and the corrugation sections run transversely to the first direction x along the second direction y. The asymmetry of the corrugation arrangement and shape can be used for vibration damping.

In addition, it should be noted that “comprising” does not exclude any other elements or steps and “a” or “an” does not exclude a plurality. Furthermore, it should be noted that features or steps which have been described with reference to one of the above exemplary embodiments can also be used in combination with other features or steps of other exemplary embodiments described above. Reference signs in the claims are not to be regarded as a restriction.

### LIST OF REFERENCE SIGNS

100 Filter system
101 Air, air flow
110 Filter device/secondary
filter plant
111 Fan unit
112 Filter element
113 Sensor element
114 Weighing device
121 Further sensor element
130 Control unit
131 Display element
132 Data storage unit
140 Central filter plant/
Primary filter plant
150 Building
151 Room
301 Conference table
302 Aerosol concentration
401 External airflow limitation
402 Dynamic pressure gauge
501 Outer fleece layer
502 Filter membrane
503 Outer fleece layer
x First direction
y Second direction
z Third direction
I First spatial region
II Second spatial region

1-33. (canceled)

34. A filter system for filtering air in rooms of a building, the filter system comprising
a filter device comprising a fan unit and a filter element which is placeable in a room,
wherein air to be filtered is flowable by means of the fan unit through the filter element for filtering,
wherein the filter device comprises a sensor element for determining at least one filter device parameter comprising at least one air parameter of the air to be filtered at the filter device or an operating parameter of the filter device,
a further sensor element which is placeable spaced apart from the filter device and is configured for determining at least one further air parameter at the further sensor element;
a control unit which is coupled to the filter device and to the further sensor element and is configured to determine at least one room state or a filter state based on the filter device parameter and the further air parameter.

35. The filter system according to claim 34,
wherein at least the air parameter or the further air parameter is selected from the group consisting of the CO content, CO2 content, the relative humidity, the air pressure, the oxygen content, the flow rate of the air, the foreign matter content comprising foreign matter particles, particle size of the foreign matter particles, foreign matter particle type, the dew point and the air temperature.

36. The filter system according to claim 34,
wherein at least the operating parameter of the filter device is selected from the group consisting of the power consumption of the filter device, the air throughput through the filter element, the volume of the fan unit, the flow volume of the through-flowing air and the temperature of the fan unit and the pressure drop of the through-flowing air over the filter element.

37. The filter system according to claim 34,
wherein the control unit is configured to determine at least the spatial state which is selected from the group consisting of a CO2 distribution in the room, a presence of persons in the room, a person occupancy in the room, a distribution of the persons in the room, noise levels in the room, at least one of a presence and a position of a source of danger, an aerosol concentration, at least one of a fine dust concentration and a virus concentration, in the room.

38. The filter system according to claim 34,
wherein the control unit is configured to determine at least the filter state which is selected from the group consisting of a filter occupancy of the filter element, a filter replacement indication and a ventilation expectation indication.

39. The filter system according to claim 34, comprising at least one of the following features:
i) wherein the control unit comprises a display element for displaying at least one of the spatial state and the filter state;
ii) wherein the further sensor element is arranged in the same room as the filter device;
iii) wherein the further sensor element is arranged in a different room than the filter device.

40. The filter system according to claim 34, further comprising
a further filter device in the room spaced apart from the filter device, wherein the further filter device comprises the further sensor element.

41. The filter system according to claim 40,
wherein the further filter device comprises a further filter element,
wherein the further filter device comprises a further fan unit.

42. The filter system according to claim 34,
wherein the control unit is configured at least one of i) to determine the position data of at least one of the filter device and of the further sensor element and ii) to take preconfigured position data into account.

43. The filter system according to claim 42,
wherein the control unit is configured, based on the position data, a thermal image map, a local distribution image of a gas concentration, a person distribution, a noise level change, an aerosol distribution, a moisture distribution, a virus distribution, a fine dust concentration distribution.

44. The filter system according to claim 34,
wherein the control unit is configured to control the filter device, based on at least one of the room state and the filter state.

45. The filter system according to claim 44,
wherein the control unit is configured to variably control the filter device such that this variation shifts the spatial suction area.

46. The filter system according to claim 34, comprising at least one of the following features:
i) wherein the control unit is configured to variably control the filter device such that at least one of a future energy availability and the current and future energy consumption of at least one of the filter system and of the building can be taken into account,
wherein the control unit automatically or partially automatically with approval function at least one of a) controls the filter device based on at least one of the future energy availability and the current and future energy consumption of at least one of the filter system and of the building and b) regulates it within a predefined range;
ii) wherein the filter element is configured such that a pressure drop of the through-flowing air through the filter element is less than 450 Pa;
iii) wherein the filter device is configured such that at least one of a) an air volume per hour and square meter of filter area is less than 600 m³/(m²×h), and
b) the velocity of the volume flow of the air through the filter device is in the range of 0.1 to 5 m/s;
iv) wherein the control unit is arranged separately from the filter device and the further sensor element;
v) at least one of a) wherein the control unit is configured to determine an energy consumption of the filter device based on at least one of the determined room state and the determined filter state, and
b) wherein the control unit is configured to determine control data for the filter device based on at least one of the determined room state and the determined filter state and at least one of a) to display these to a user and b) to automatically control at least one filter device by means of the control data;
vi) wherein the control unit is configured to analyze the room state based on the determined fine dust as air parameter;
vii) wherein the control unit is coupled to at least one of the filter device and to the further sensor element for wireless signal exchange of sensor signals or control commands, wherein the filter device provides filter-related data to the control unit;
viii) wherein the control unit obtains a UniqueID from the filter device, wherein the UniqueID comprises information relating to the location of use of the filter device,
wherein the control device receives the UniqueID via NFC, Bluetooth, WLAN, proprietary protocols or protocols of building control systems,
wherein at least one of the operation and the configuration of the filter device can be set based on the UniqueID.

47. The filter system according to claim 34,
wherein the filter element comprises a filter material which contains one layer of fleece,
wherein the filter element is exchangeably arrangeable in the filter device.

48. The filter system according to claim 47,
wherein the filter element comprises at least two fleece layers and a filter membrane arranged between the fleece layers, which are arranged in a layered manner one above the other in a layered composite.

49. The filter system according to claim 48,
wherein a first direction, x, and a second direction, y, span a plane,
wherein the middle filter membrane is configured to be corrugated with corrugation sections such that the corrugation sections are arranged one behind the other along a first direction, x,
wherein the corrugation sections run irregularly and asymmetrically to one another, and
wherein the filter element is arranged such that air is flowable over the filter element along the first direction, x, or along the second direction, y.

50. The filter system according to claim 49,
at least one of wherein the filter element has a thickness of 2 mm to 10 mm, and
wherein the number of corrugation sections is between 0.5 and 3 corrugations per cm.

51. The filter system according to claim 34, comprising at least one of the following features:
i) wherein the filter element comprises a filter material which at least one of a) is hydrophobic and b) contains a natural fiber or a polyolefin;
ii) wherein the filter device comprises a weighing device which is configured to weigh the filter occupancy of the filter element;
iii) wherein the filter device comprises an electrical supply unit which is configured to obtain energy by means of at least one of the air flow through the filter device and by electromagnetic waves, which energy is used in particular for operating at least one of the sensor element and the filter device;
iv) further comprising
a data storage unit which is coupled to the control unit, to the filter device and to the further sensor element for exchanging data;
v) at least one of a) wherein the sensor element is a dynamic pressure gauge, and
b) wherein the sensor element comprises a microphone which is configured to detect the noise level in a room such that the number and intensity of speech-active persons in the room can be determined by means of measuring and evaluating the noise level in the room.

52. A building, comprising,
a plurality of rooms,
a filter system according to claim 34,
wherein the filter system comprises a central ventilation system which comprises at least one further fan unit and in each case one ventilation outlet in the corresponding rooms,
wherein the control unit is configured to control the further fan unit,
wherein the control unit controls at least one of the filter device and the central ventilation system based on at least one of the room state and the filter state.

53. A method for filtering air in rooms of a building with a filter system according to claim 34.
